(19) United States
(12) Patent Application Publication
(10) Pub. No.: US 2013/0335905 A1
(43) Pub. Date: Dec. 19, 2013

(54) FOLDABLE KEYBOARD

(71) Applicants: HONG FU JIN PRECISION INDUSTRY (ShenZhen) CO., LTD., (US); HON HAI PRECISION INDUSTRY CO., LTD., New Taipei (TW)

(72) Inventor: ZHEN-WEI XU, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/859,531

(22) Filed: Apr. 9, 2013

(30) Foreign Application Priority Data
Jun. 18, 2012 (CN) 201210200759.5

(51) Int. Cl. G06F 1/16

(52) U.S. Cl. CPC G06F 1/1666
USPC 361/679.08

(57) ABSTRACT

A foldable keyboard includes a first keyboard portion, a second keyboard portion, a third keyboard portion rotatably connected to each other; and a control unit. The control unit includes a detecting module and a processing module. The detecting module detects relative distance between the first keyboard portion, the second keyboard portion and the third keyboard portion, and outputting an electronic signal to the processing module. The processing module receives the electronic signal and computes a distance value. The processing module compares the distance vale with a predetermined standard range value for determining different work modes of the keyboard.

### BACKGROUND

1. Technical Field

The disclosure generally relates to keyboards, and particularly to a foldable keyboard for an electronic device.

2. Description of Related Art

Portable electronic devices, such as tablet computers, are widely used. The tablet computers are operated through a touch screen, and are typically not equipped with a traditional keyboard. Some users like to operate the tablet computer through use of a traditional keyboard to input information. However, the traditional keyboard is inconvenient to carry. Additionally, the traditional keyboard can only provide a single key function, which may not be flexible enough.

Therefore, there is room for improvement within the art.

### BRIEF DESCRIPTION OF THE DRAWINGS

Many aspects of the exemplary foldable keyboard can be better understood with reference to the following drawings. The components in the drawings are not necessarily drawn to scale, the emphasis instead being placed upon clearly illustrating the principles of the foldable keyboard. Moreover, in the drawings, like reference numerals designate corresponding parts throughout the several views, in which:

FIG. 1 is an isometric view of a foldable keyboard connected to a tablet personal computer.

FIG. 2 is an isometric view of the foldable keyboard of FIG. 1 in a partially folded state.

FIG. 3 is an isometric view of the foldable keyboard of FIG. 2 in a stacked state.

FIG. 4 is an isometric view of the foldable keyboard of FIG. 2 in a triangular state.

FIG. 5 is a schematic view of the foldable keyboard of FIG. 4 used for supporting the tablet personal computer.

FIG. 6 is a block view of a control unit of the foldable keyboard.

### DETAILED DESCRIPTION

The disclosure is illustrated by way of example and not by way of limitation in the accompanying drawings. It should be noted that references to “an” or “one” embodiment in this disclosure are not necessarily to the same embodiment, and such references can include the meaning of “at least one” embodiment where the context permits.

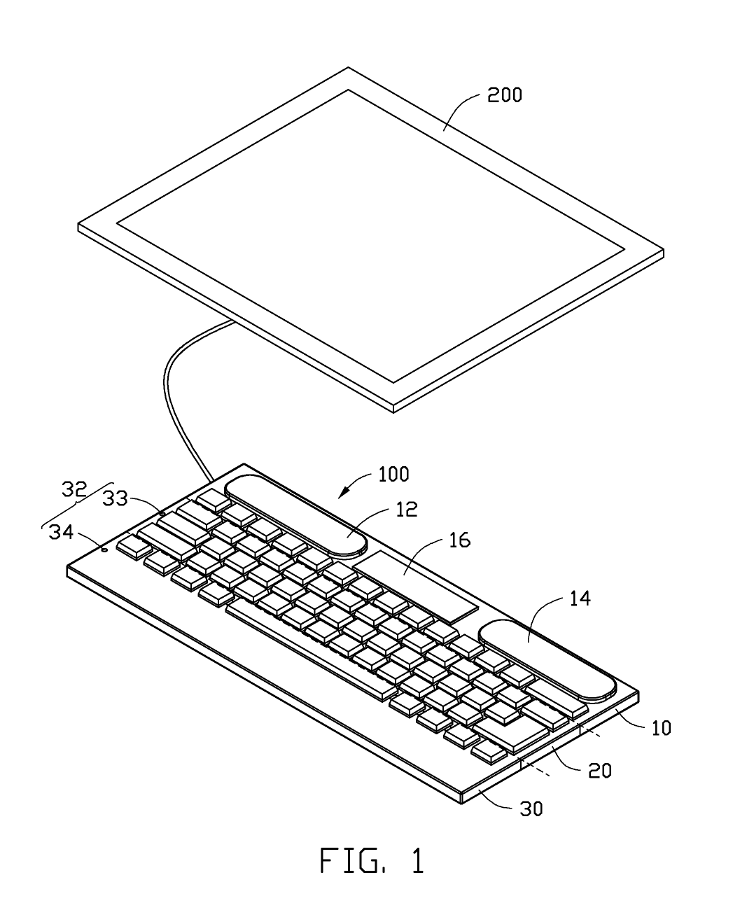

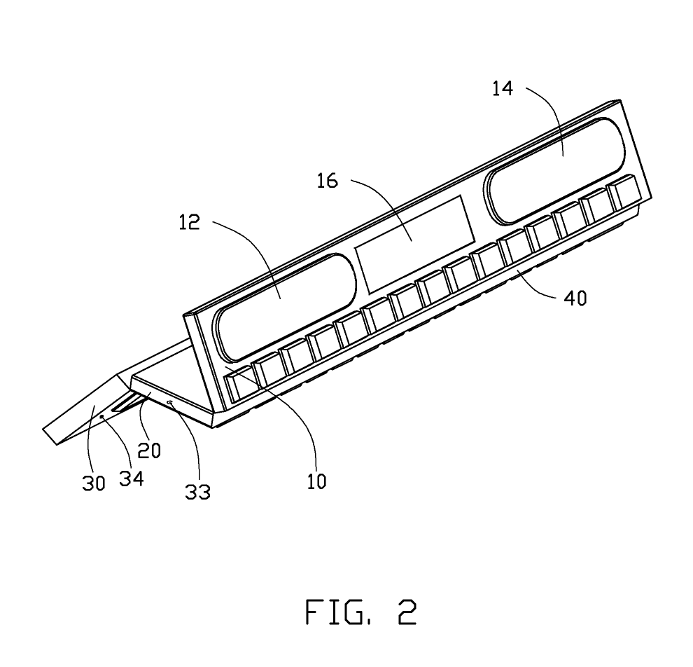

FIGS. 1 and 2 illustrate a foldable keyboard 100 used for connecting to an electronic device, such as tablet computer 200. The tablet computer 200 is an exemplary application, for the purposes of describing details of the foldable keyboard 100. The foldable keyboard 100 shown herein for illustrative purpose is connected to the tablet personal computer 200 in a wired mode. However, the foldable keyboard 100 may be connected to the tablet personal computer 200 in a wireless mode, such as BLUETOOTH.

The foldable keyboard 100 may be folded to several different states, such as in a folded state and in an unfolded state, and can work in different modes according to the folded and unfolded states. The foldable keyboard 100 can work as a common keyboard in an unfolded state, and also work as a mobile phone or sound equipment.

The foldable keyboard 100 includes a first keyboard portion 10, a second keyboard portion 20, a third keyboard portion 30, and two shafts 40. The first keyboard portion 10 is rotatably connected to the second keyboard portion 20 via a first shaft 40. The second keyboard portion 20 is rotatably connected to the third keyboard portion 30 via a second shaft 40. A first sound box 12 and a second sound box 14 are positioned on the first keyboard portion 10. A display 16 is positioned between the first sound box 12 and the second sound box 14. When the foldable keyboard 100 is completely unfolded, the first keyboard portion 10, the second keyboard portion 20 and the third keyboard portion 30 are coplanar, and the foldable keyboard 100 functions as a common keyboard.

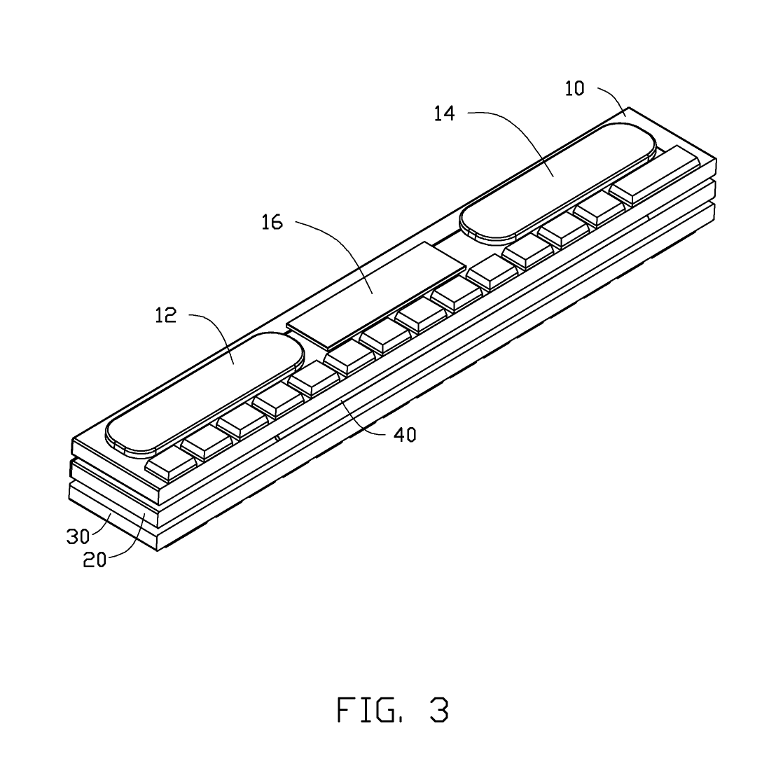

In FIGS. 2 and 3, the first keyboard portion 10, the second keyboard portion 20 and the third keyboard portion 30 can be folded around the shafts 40 to allow the first keyboard portion 10, the second keyboard portion 20 and the third keyboard portion 30 to be stacked with each other. The second keyboard portion 20 is sandwiched between the first keyboard portion 10 and the third keyboard portion 30. At this state, the keyboard 100 may function as a mobile phone.

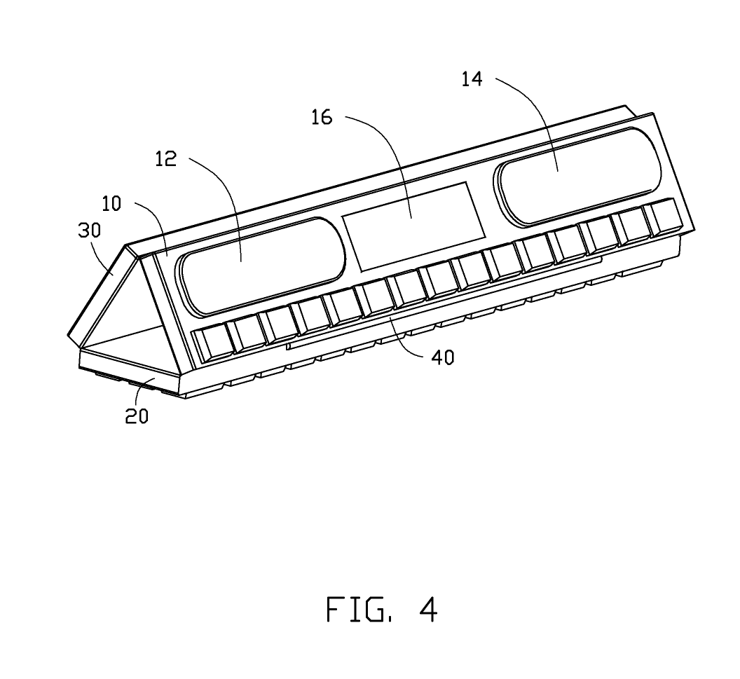

In FIG. 4, the keyboard 100 may be folded to be in a triangular state. A free end of the first keyboard portion 10 abuts against a free end of the third keyboard portion 30. At this state, the keyboard 100 may function as a sound equipment.

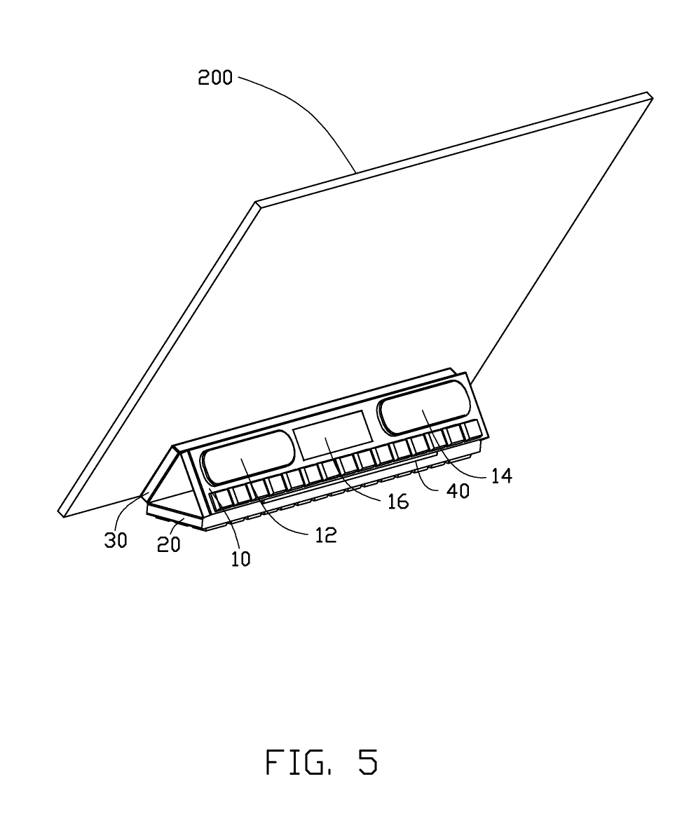

In FIG. 5, when the keyboard 100 is folded to be in a triangular state, the keyboard 100 may function as a stand of the tablet computer 200. The tablet computer 200 is supported by the folded keyboard 100 in a predetermined position to allow the tablet computer 200 to be at a comfortable viewing angle.

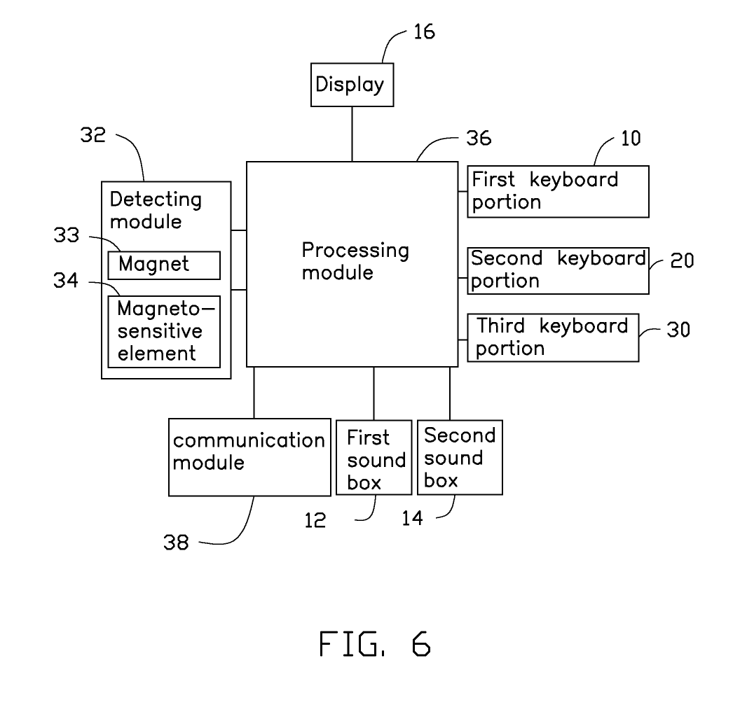

In FIG. 6, the foldable keyboard 100 has a control unit to allow the keyboard 100 to work in different modes. The control unit includes a detecting module 32, a processing module 36 and a communication module 38. The detecting module 32 is electronically connected to the processing module 36, and the communication module 38 is electronically connected to the processing module 36.

The detecting module 32 is configured to detect relative distances between the first keyboard portion 10, the second keyboard portion 20 and the third keyboard portion 30. In this exemplary embodiment, the detecting module 32 is configured to detect the distance between the second keyboard portion 20 and the third keyboard portion 30. The detecting module 32 includes a magnet 33 and a magneto-sensitive element 34. The magnet 33 is positioned on the second keyboard portion 20, and the magneto-sensitive element 34 is positioned on the third keyboard portion 30. When a relative distance between the second keyboard portion 20 and the third keyboard portion 30 is varied, the magnetic flux between the magnet 33 and the magneto-sensitive element 34 will change, resulting in the magneto-sensitive element 34 outputting an electronic signal. The processing module 36 receives the electronic signal for computing the relative distance. The processing module 36 compares the relative distance with a predetermined standard range value to control the foldable keyboard 100 to work in different modes.

The processing module 36 is electronically connected to the first keyboard portion 10, the second keyboard portion 20 and the third keyboard portion 30. When the foldable keyboard 100 is stacked, the processing module 36 controls the communication module 38 to work for realizing the mobile phone function. To prevent the keys on the second keyboard portion 20 and the third keyboard portion 30 from accidentally being pressed, the processing module 36 controls the keys on the second keyboard portion 20 and the third keyboard portion 30 to not work, and allows the keys on the first keyboard portion 10 to work. In this situation, the keys on the first keyboard portion 10 may work similar to the keys on the mobile phone.

The processing module 36 is electronically connected to the first sound box 12 and the second sound box 14. When the foldable keyboard 100 is folded in a triangular shape, the processing module 36 controls the first sound box 12 and the second sound box 14 to work.

The processing module 36 is electronically connected to the display 16. When the foldable keyboard 100 works in different modes, the display 16 will show the work state for conveniently informing the user.

In use, when the foldable keyboard 100 is folded, the relative distance between the second keyboard portion 20 and the third keyboard portion 30 is varied, the magnetic flux between the magnet 33 and the magneto-sensitive element 34 will result in the magneto-sensitive element 34 outputting an electronic signal. The processing module 36 receives the electronic signal for communicating the relative distance. The processing module 36 will compare the relative distance with a predetermined standard range value.

If the relative distance is larger than the standard range value, the processing module 36 determines that the foldable keyboard 100 is completely unfolded. The processing module 36 controls the first keyboard portion 10, the second keyboard portion 20 and the third keyboard portion 30 to work. If the relative distance is within the standard range value, the processing module 36 determines that the foldable keyboard 100 is folded in a triangular state. The processing module 36 controls the first sound box 12 and the second sound box 14 to work. If the relative distance is smaller than the standard value, the processing module 36 determines that the foldable keyboard 100 is stacked. The processing module 36 controls the communication module 38 to work. At the same time, the processing module 36 controls the keys on the second keyboard 20 and the third keyboard 30 not to work, and allows the keys on the first keyboard portion 10 to work.

The exemplary embodiments of the keyboards 100 can be folded, thus, the keyboard 100 is easy to carry and use.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A foldable keyboard, comprising:
a first keyboard portion, a second keyboard portion, a third keyboard portion rotatably connected to each other; and
a control unit comprising:
a detecting module detecting a relative distance between the first keyboard portion, the second keyboard portion and the third keyboard portion, and outputting an electronic signal according to the relative distance to the processing module;
a processing module computing a distance value using the electronic signal, the processing module comparing the distance value with a predetermined standard range value for determining different work modes of the keyboard.

2. The foldable keyboard as claimed of claim 1, wherein the first keyboard portion is rotatably connected to the second keyboard portion via a first shaft, and the second keyboard portion is rotatably connected to the third keyboard portion via a second shaft.

3. The foldable keyboard as claimed of claim 1, wherein a first sound box and a second sound box are positioned on the first keyboard portion, and wherein a display is positioned between the first sound box and the second sound box.

4. The foldable keyboard as claimed of claim 1, wherein the detecting module includes a magnet and a magneto-sensitive element, the magnet is positioned on the second keyboard portion, and the magneto-sensitive element is positioned on the third keyboard portion.

5. A foldable keyboard comprising:
a first keyboard portion, a second keyboard portion, a third keyboard portion rotatably connected to each other; and
a control unit comprising:
a detecting module detecting a relative distance between the first keyboard portion, the second keyboard portion and the third keyboard portion, and outputting an electronic signal according to the relative distance to the processing module; and
a processing module computing a distance value using the electronic signal, the processing module comparing the distance value with a predetermined standard range value for determining different work modes of the keyboard;
a communication module electronically connected to the processing module;
wherein when the processing module determines that the foldable keyboard is completely unfolded, the processing module controls the first keyboard portion, the second keyboard portion and the third keyboard portion to work;
when the processing module determines that the first keyboard portion, the second keyboard portion and the third keyboard portion are stacked with each other, the processing module controls the communication module to work;
when the processing module determines that the first keyboard portion, the second keyboard portion and the third keyboard portion are folded in a triangular state, the processing module controls the foldable keyboard as a sound equipment.
